(19) United States
(12) Patent Application Publication
(10) Pub. No.: US 2008/0005723 A1
(43) Pub. Date: Jan. 3, 2008

(54) Method For Manipulating Software-Tests

(76) Inventor: Peter Zimmerer, Munchen (DE)

Correspondence Address: HARNESS, DICKEY & PIERCE, P.L.C., P.O.BOX 8910, RESTON, VA, 20195, US

(21) Appl. No.: 11/667,658

(22) PCT Filed: Sep. 13, 2005
(86) PCT No.: PCT/EP05/54545

§ 371 Date: May 14, 2007

(30) Foreign Application Priority Data
Nov. 15, 2004 (DE) 10 2004 055 052.2

(51) Int. Cl. G06F 9/44

(52) U.S. Cl. 717/124

(57) ABSTRACT

Embodiments of the invention relate to the specification and implementation of tests on a higher abstraction plane using a declarative description with the aid of aspects (cross-cutting concerns). According to an embodiment of the invention, specific tests are provided with “aspects” that result automatically in new, extended, more powerful tests. This leads advantageously to the simplification of the specification of tests, a re-usability and extensibility of tests and to a simple coupling and combination of tests. For example, functional tests can be provided with the aspect time, which automatically results in performance tests.

### PRIORITY STATEMENT

This application is the national phase under 35 U.S.C. § 371 of PCT International Application No. PCT/EP2005/054545 which has an International filing date of Sep. 13, 2005, which designated the United States of America and which claims priority on German Patent Application number 10 2004 055 052.2 filed Nov. 15, 2004, the entire contents of which are hereby incorporated herein by reference.

### FIELD

Embodiments of the invention generally relate to a method for manipulating—for example for describing, specifying and implementing—software tests, such as for instance functional tests, performance tests, load and stress tests, long time tests, tests which simultaneously analyze the resource consumption, such as for instance delay time and memory requirements, safety tests etc.

### BACKGROUND

The ways to express the description, specification and implementation of tests has previously been relatively restricted. These different types of tests have until now been typically painstakingly specified in a fine-grained manner and have been detailed in test scripts and manually converted into a corresponding program.

The webpage http://www.cs.ecnu.edu.cn/sel/˜harryxu/research/myresearch.htm#test discloses an AOTL (Aspect-Oriented Test Description Language) as an extension of a test automation framework (JUnit, see http://www.junit.org) based on JMP (Java Modeling Language, http://www.cs.iastate.edu/˜leavens/JML/). It is however only used in a conventional manner to generate unit test code and to generate a fairly restricted test oracle (of the target values).

### SUMMARY

At least one embodiment of the invention specifies an improved and/or more comprehensive method for manipulating software tests, which is not just restricted to the generation of unit test code and simple test oracles and/or target values, in other words to a special test phase and a special test activity.

### DETAILED DESCRIPTION OF THE EXAMPLE EMBODIMENTS

An embodiment of the invention relates to the specification and implementation of tests on a higher abstraction plane using a declarative description with the aid of “aspects” (cross-cutting concerns), with specific tests being provided with such “aspects”, that then result automatically in new, extended and more powerful tests. This leads advantageously to the simplification of the specification of tests, a reusability and extensibility of tests and to a simple coupling and combination of tests. For example, functional tests can thus be provided with the aspect “time” and automatically then result in performance tests.

With the method according to an embodiment of the invention, a specification and implementation of tests on a higher abstraction plane is carried out using a declarative description with the aid of aspects which are similar to those as are known from the so-called “AOP or aspect orientated programming” from software programming, which is used for the advantageous concentrated realization of specific cross-cutting concerns.

The aspects are, as also with “AOP”, inserted into already existing basic tests by way of a so-called “aspect weaver”, i.e. an instrumentation of these basic tests takes place. The resulting new tests are then executed by means of compilers or interpreters, e.g. in a test execution environment.

Functional tests are thus provided, in accordance with at least one embodiment of the invention, for instance by adding the aspect “Timing info” to performance tests, by adding an aspect of “100,000 h” for instance to a long time test and/or to a corresponding load and stress test or by adding safety aspects to safety tests or security tests.

Finally, negative tests or marginal value tests can be formed in a simple manner in accordance with the invention even from positive tests for instance by adding an aspect “Exception/Error Paths”.

Advantages of at least one embodiment include,
A simplification of both the specification and also the implementation of tests by using a higher abstraction plane by means of a declarative description with the aid of aspects, since each detail no longer needs to be individually specified and manually programmed.
A reuse and extension of tests is possible in a simple manner.
A coupling and combination of tests is herewith possible in a simple manner, thereby leading to more powerful resulting tests.
A specification and implementation of more complex tests is possible.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for manipulating a software tests, with which at least one respective specification and implementation of a new software test is carried out, the method comprising at least one of:
using an AOP aspect weaver to insert a respective aspect representing multi-test concerns into software to be tested, wherein this is accordingly instrumented and a basic test arises therefrom; and
adding at least one further aspect representing a multi-test concern to a previous basic test such that an AOP aspect weaver is used to insert the at least one further aspect into the previous basic test, wherein this is additionally accordingly instrumented.

2. The method as claimed in claim 1, wherein performance tests are formed by adding an aspect which represents the timing information to previous functional tests.

3. The method as claimed in claim 1, wherein at least one of a long time test and a corresponding load and stress test is formed by adding an aspect which represents long time test concerns to previous functional tests.

4. The method as claimed in claim 1, wherein a safety test is formed by adding an aspect which represents safety concerns to previous functional tests.

5. The method as claimed in claim 1, wherein at least one of a negative test and a marginal value test is formed by adding an aspect which represents exception concerns and error concerns to a corresponding positive test.

6. A method for manipulating a software test, with which at least one respective specification and implementation of a new software test is carried out, the method comprising at least one of:
inserting a respective aspect representing multi-test concerns, via an AOP aspect weaver, into software to be tested,
instrumenting the software, and
creating a basic test therefrom; and
inserting at least one further aspect, representing a multi-test concern to a basic test, into the basic test via an AOP aspect weaver.

7. The method as claimed in claim 6, wherein performance tests are formed by adding an aspect which represents the timing information to previous functional tests.

8. The method as claimed in claim 6, wherein at least one of a long time test and a corresponding load and stress test is formed by adding an aspect which represents long time test concerns to previous functional tests.

9. The method as claimed in claim 6, wherein a safety test is formed by adding an aspect which represents safety concerns to previous functional tests.

10. The method as claimed in claim 6, wherein at least one of a negative test and a marginal value test is formed by adding an aspect which represents exception concerns and error concerns to a corresponding positive test.
